(19) United States
(12) Patent Application Publication
(10) Pub. No.: US 2012/0063804 A1
(43) Pub. Date: Mar. 15, 2012

(54) CHARGING DEVICE, PROCESS CARTRIDGE AND IMAGE FORMING APPARATUS

(75) Inventors: Daisuke Yamashita, Shizuoka-ken (JP); Takeshi Watanabe, Kanagawa-ken (JP); Masashi Takahashi, Kanagawa-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/223,798

(22) Filed: Sep. 1, 2011

Related U.S. Application Data
(60) Provisional application No. 61/381,129, filed on Sep. 9, 2010.

(51) Int. Cl. G03G 15/02

(52) U.S. Cl. 399/100

(57) ABSTRACT

A charging device includes a charging member that is arranged close to a rotating charge target member, and charges a charge target surface of the charge target member while rotating, a cleaning member that makes friction contact with the charging member to cause the charging member to be driven and rotated, and cleans a surface of the charging member, and a cleaning member driving part to rotate and drive the cleaning member.

### CROSS-REFERENCE TO RELATED APPLICATION

This application is based upon and claims the benefit of priority from: US provisional application, 61/381,129, filed on Sep. 9, 2010; the entire contents of each of which are incorporated herein by reference.

### FIELD

Embodiments described herein relate generally to a driving technique of a charging roller to charge a photoconductive drum as an image carrier in an electrophotographic image forming process.

### BACKGROUND

In an electrophotographic image forming process, a photoconductive drum as an image carrier is charged to a uniform potential by a charging device. In the charging device, a non-contact charging roller system is proposed in which the photoconductive drum is charged in a non-contact manner by a charging roller. The charging roller has such a structure that a resistance adjustment layer, such as a conductive resin layer or elastic layer, is provided on a peripheral surface of a conductive support of metal or the like, and a gap keeping member having a diameter slightly larger than an outer diameter of the resistance adjustment layer is provided at both ends of the resistance adjustment layer. The gap keeping member is made to contact both ends of the outer peripheral surface of the photoconductive drum, so that a slight gap is formed between the outer peripheral surface of the photoconductive drum and the resistance adjustment layer as the outer peripheral surface of the charging roller. An electrical discharge is generated in the gap by the charging roller, and the photoconductive drum is charged to the uniform potential.

When the charging roller is discharged in a fixed state, the electrical discharge is always generated from the same place, and partial deterioration occurs. Thus, the charging roller and the photoconductive drum are coupled by a gear, the rotation of the photoconductive drum is transmitted to the charging roller, and the electrical discharge is performed while the charging roller is rotated.

As a drive mechanism to rotate the charging roller relative to the photoconductive drum, in the structure where the photoconductive drum and the charging roller are coupled by the gear, a gear part is provided at both the ends of the photoconductive drum in an axial direction. As a result, in the photoconductive drum, the width of the gear is added to the width of the contact with the gap keeping member of the charging roller, and the length of the photoconductive drum in the axial direction becomes long. Thus, an improvement in the rotation drive mechanism of the charging roller is desired.

### DESCRIPTION OF THE DRAWINGS

FIG. 1 is a vertical sectional view showing an embodiment of an image forming apparatus.

FIG. 2 is a schematic front view of a process cartridge of FIG. 1.

FIG. 3 is a side view showing an assembly state of a photoconductive drum, a charging roller and a cleaning roller contained in the process cartridge of FIG. 2.

FIG. 4 is a front view showing a driving part that is coupled to four-color process cartridges mounted in the image forming apparatus, and drives a photoconductive drum and a cleaning roller of each of the process cartridges.

FIG. 5 is a view showing another embodiment of a rotating mechanism of a charging roller.

FIG. 6 is a view showing the another embodiment of a driving part to drive a photoconductive drum of a process cartridge of FIG. 5.

### DETAILED DESCRIPTION

In general, according to one embodiment, a charging device includes a charge target member that rotates, a charging member that is arranged close to the charge target member, has a same movement direction as the charge target member and charges a charge target surface of the charge target member while rotating, a cleaning member that makes friction contact with the charging member to cause the charging member to be driven and rotated and cleans a surface of the charging member, and a cleaning member driving part to rotate and drive the cleaning member.

The charge target member is a photoconductive drum, the charging member is a charging roller, and the cleaning member is a cleaning roller.

The photoconductive drum rotates around a photoconductive drum shaft, and the cleaning roller rotates around a cleaning roller shaft.

The photoconductive drum shaft is coupled to a driving part of a first driving device provided in an image forming apparatus main body. The cleaning roller shaft is coupled to a driving part of a second driving part provided in the image forming apparatus main body. The photoconductive drum shaft and the cleaning roller shaft are driven by separate motors.

### First Embodiment

First, a first embodiment will be described with reference to the drawings.

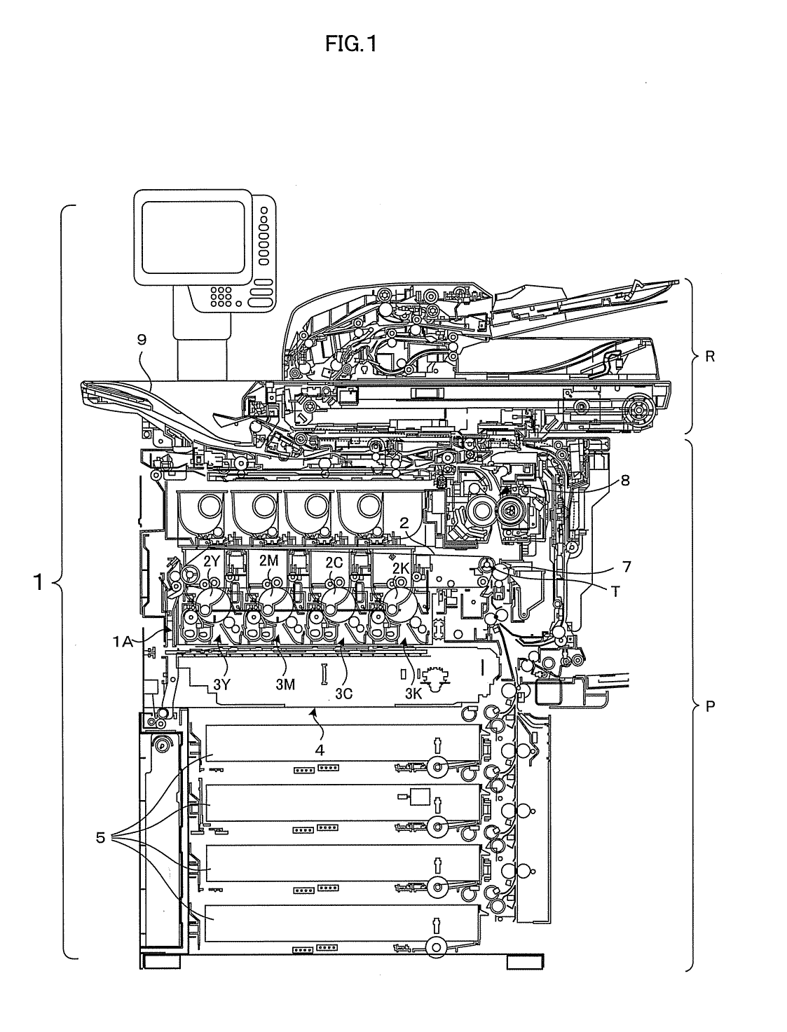

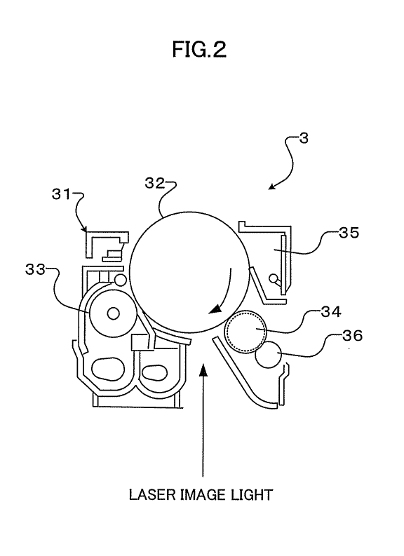

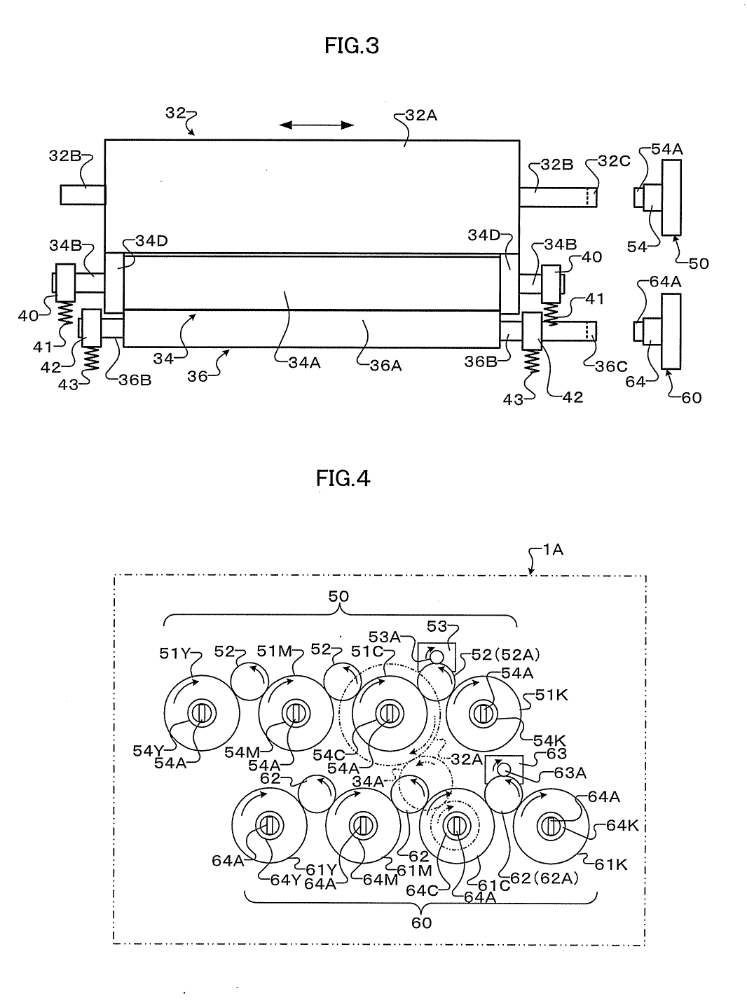

FIG. 1 is a vertical sectional view of an image forming apparatus of a first embodiment, FIG. 2 is a schematic front view of a process cartridge replaceably mounted in the image forming apparatus of FIG. 1, FIG. 3 is a side view showing an assembly state of a photoconductive drum, a charging roller and a cleaning roller contained in the process cartridge of FIG. 2, and FIG. 4 is a front view showing a driving part that is coupled to four-color process cartridges mounted in the image forming apparatus, and drives a photoconductive drum and a cleaning roller of each of the process cartridges.

In FIG. 1, an MFP (Multi Function Peripheral) 1 as an image forming apparatus includes an image reading part R and a printer part P. The printer part P includes process cartridges 3Y, 3M, 3C and 3K of four colors of yellow, magenta, cyan and black, which are replaceably arranged below an endless transfer belt 2. A laser device 4 to form an image exposure light is arranged below the process cartridges 3 (3Y, 3M, 3C and 3K), and plural paper feed cassettes 5 to contain print sheets are arranged in tiers below the laser device.

As shown in FIG. 2, the process cartridge 3 (3Y, 3M, 3C and 3K) includes, in an outer case 31, a photoconductive drum 32 as a charge target member, a developing unit 33, a charging roller 34 as a charging member, a toner containing box 35 which scrapes toner remaining on the photoconductive drum 32 by a cleaning blade and contains the toner, and a cleaning roller 36 which cleans the surface of the charging roller 34 of a non-contact charging roller type. In the charging device of the non-contact charging roller type, as the use time of the charging roller 34 increases, foreign matter, such as paper powder, adhered to the surface of the charging roller 34 prevents stable electrical discharge, and prevents a gap between the surface of the charging roller and the surface of the photoconductive drum from being kept constant. Thus, cleaning of the surface of the charging roller 34 is performed by contact with the cleaning roller 36.

A laser image light incident on the process cartridge 3 (3Y, 3M, 3C and 3K) of each color from the laser device 4 scans the rotating photoconductive drum 32 and forms a latent image. The latent image on the photoconductive drum 32 is developed with the toner of the developing unit 33, and a developer image is transferred onto the transfer belt 2 by a primary transfer roller 6. The toner remaining on the photoconductive drum 32 is scraped by the cleaning blade and is contained in the toner containing box 35. The photoconductive drum 32 is charged to a uniform potential by the charging roller 34 and is used for next image formation.

A toner image T carried on the transfer belt 2 is transferred onto a sheet fed from the paper feed cassette 5 by a secondary transfer roller 7, and is heated, pressed and fixed by a fixing device 8. The sheet subjected to the fixing is discharged onto a paper discharge tray 9.

As shown in FIG. 3, the photoconductive drum 32 includes a photoconductive drum main body 32A and photoconductive drum shafts 32B respectively extending outward in an axial direction from both ends of the photoconductive drum main body 32A, and is rotatably supported by the outer case 31 of the process cartridge 3 through not-shown bearing parts. The photoconductive drum 32 rotates around the photoconductive drum shafts 32B. In the photoconductive drum 32, the photoconductive drum main body 32A is constructed such that a single layer or laminated layer of a photoconductive layer is provided on a cylindrical metal raw pipe of aluminum or the like.

The charging roller 34 includes a charging roller main body 34A provided with a resistance adjustment layer, such as a conductive resin layer or elastic layer, on a peripheral surface of a conductive support of metal or the like, charging roller shafts 34B respectively extending outward from both ends of the charging roller main body 34A in an axial direction, and gap keeping members 34D provided at both end parts of the charging roller main body 34A and each having a diameter slightly larger than an outer diameter of the resistance adjustment layer. The respective gap keeping members 34D contact both end parts of the outer peripheral surface of the photoconductive drum 32, so that a specified gap is formed between the outer peripheral surface of the charging roller main body 34A of the charging roller 34 and the outer peripheral surface of the photoconductive drum 32. Both the charging roller shafts 34B are rotatably supported by bearing members 40. The charging roller 34 rotates around the charging roller shafts 34B.

Both the bearing members 40 are pressed to the photoconductive drum 32 by spring forces of pressing springs 41. Thus, when the charging roller 34 and the photoconductive drum 32 rotate, the gap is kept constant.

The gap keeping member 34D is preferably formed of resin. When the gap keeping member 34D is conductive, an electric leakage to the photoconductive drum 32 occurs. Thus, the gap keeping member is preferably insulative or has a sufficiently high resistance.

The cleaning roller 36 includes a cleaning roller main body 36A formed of, for example, a brush roller using a brush fiber, a sponge roller using a foamed body or a rubber roller using an elastic body, and cleaning roller shafts 36B respectively extending outward in an axial direction from both ends of the cleaning roller main body 36A. The cleaning roller 36 rotates around the cleaning roller shafts 36B.

The cleaning roller main body 36A contacts the charging roller main body 34A at the inside between both the gap keeping members 34D. Both the cleaning roller shafts 36B are rotatably supported by bearing members 42. The bearing members 42 are pressed to the charging roller main body 34A by spring forces of pressing springs 43, so that the cleaning roller main body 36A is brought into press contact with the charging roller main body 34A, and the cleaning roller main body 36A and the charging roller main body 34A make friction contact with each other. Incidentally, when a rubber roller is used as the cleaning roller 36, the friction coefficient relative to the charging roller 34 becomes large, and the rotation efficiency of the driven and rotated charging roller 34 can be increased.

In this embodiment, as shown in FIG. 3 and FIG. 4, for the four-color process cartridges 3 (3Y, 3M, 3C, 3K), a first driving device 50 provided in an MFP main body 1A drives the photoconductive drum 32, and a second driving device 60 drives the cleaning roller 36. The first driving device 50 and the second driving device 60 have basically the same structure, and are provided at the back side of the mounting positions of the respective process cartridges 3Y, 3M, 3C and 3K.

In the first driving device 50, drive gears 51Y, 51M, 51C and 51K are arranged to be opposite to the photoconductive drum shafts 32B at the back sides of the photoconductive drums 32 of the respective process cartridges 3Y, 3M, 3C and 3K, and coupling gears 52 are disposed between the gears (51Y, 51M, 51C and 51K). When one coupling gear (drive coupling gear) 52A is driven, all the drive gears 51Y, 51M, 51C and 51K are rotated in the same direction. The drive coupling gear 52A is engaged with a motor gear 53A of a first drive motor 53, and when the first motor gear 53A is rotated in an arrow direction, the drive gears 51Y, 51M, 51C and 51K are rotated in the same direction as the movement direction of the transfer belt 2.

Coupling shaft 54Y, 54M, 54C and 54K are coaxially attached to the drive gears 51Y, 51M, 51C and 51K.

On the other hand, a groove part 32C extending in, for example, a diameter direction is formed at a tip of the photoconductive drum shaft 32B at the back side of the photoconductive drum 32 of each of the process cartridges 3Y, 3M, 3C and 3K. When the process cartridge 3 is pressed into to the specified position of the MFP main body 1A along an arrow direction, the groove part 32C is fitted to a projection part 54A formed at the tip of the coupling shaft 54 (54Y, 54M, 54C and 54K), and the driving force can be transmitted.

Besides, when the process cartridge 3 is pressed into to the specified position, a groove part 36C of the cleaning roller shaft 36B at the back side of the cleaning roller 36 is fitted to a projection 64A of a coupling shaft 64 (64Y, 64M, 64C, 64K) of the second driving device 60 similarly to the photoconductive drum shaft 32B.

That is, the first driving device 50 includes a driving part to drive the four photoconductive drums 32 by the one motor 53.

When a second drive motor 63 of the second driving device 60 is driven, a drive coupling gear 62A is rotated by a motor gear 63A, and drive gears 61C and 61K are rotated, and other drive gears 61Y and 61M are rotated in arrow directions through other coupling gears 62.

The friction contact state between the charging roller main body 34A and the cleaning roller main body 36A is kept, and when the cleaning roller main body 36A indicated by a chain double-dashed line in FIG. 4 is rotated, rotating force in an arrow direction is transmitted to the charging roller 34 indicated by a chain double-dashed line by coupling rotation.

On the other hand, movement directions of the charging roller 34 and the photoconductive drum 32 at the contact portion between the gap keeping member 34D of the charging roller 34 and the photoconductive drum 32 are the same direction. Thus, when movement speeds (peripheral speeds) of the charging roller 34 and the photoconductive drum 32 at the contact portion are made equal to each other, the charging roller 34 can be smoothly driven and rotated by the cleaning roller 36.

Here, when the peripheral speed is v (m/s), the diameter of the photoconductive drum is D1, the rotation speed (rpm) is N1, and the circular constant is π, the peripheral speed is obtained by v=πD1·N1. Besides, when the diameter of the charging roller (gap keeping member 34D) is D2 (D2≠D1), and the rotation speed (rpm) is N2, the peripheral speed is obtained by v=πD2·N2. Thus, when the rotation speeds N1 and N2 and the diameters D1 and D2 are set so that (N1/N2)=(D2/D1), the peripheral speeds can be made equal to each other.

In this embodiment, the charging roller 34 is rotated and driven by the cleaning roller 36, and rotates at the same peripheral speed as the outer peripheral surface of the photoconductive drum main body 32A of the photoconductive drum 32 while moving in the same direction. The charging roller main body 34A rotates and discharges to the rotating photoconductive drum main body 32A, and charges the photoconductive drum main body 32A. That is, the second driving device 60 includes a driving part to drive the four cleaning rollers 36 by the one motor 63.

In this embodiment, although the example is described in which the photoconductive drum 32 and the cleaning roller 36 of the process cartridge 3 are driven by the first driving device 50 and the second driving device 60, the driving device of the cleaning roller 36 is not limited to this structure. For example, the cleaning roller may be driven by a driving force of a driving member existing on the periphery of the charging roller rotation shaft 36B.

### Second Embodiment

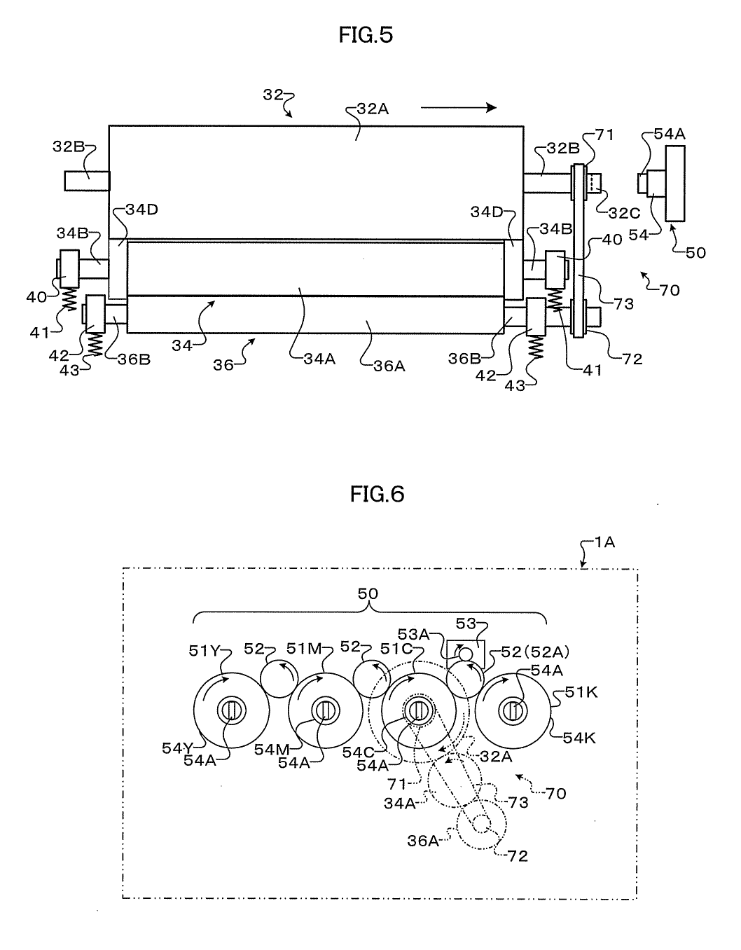

FIG. 5 and FIG. 6 show a second embodiment. In the second embodiment, a first driving device 50 drives a photoconductive drum shaft 32B of a process cartridge 3, a cleaning roller shaft 36B of a process cartridge 3 is rotated by the rotation of the photoconductive drum shaft 32B through a belt transmission type driving part 70, and a charging roller 34 which is in friction contact with a cleaning roller 36 is driven and rotated similarly to the first embodiment.

In this embodiment, the belt transmission type driving part 70 includes an endless power transmission belt 73 stretched between a first pulley 71 provided on the photoconductive drum shaft 32B and a second pulley 72 provided on the cleaning roller shaft 36B. Also in this embodiment, peripheral speeds of a photoconductive drum main body 32A and a charging roller main body 34A (gap keeping member 34D) are made equal to each other.

In this embodiment, a dedicated driving device to drive the cleaning roller 36 is not required.

Incidentally, in the above respective embodiments, although the process cartridges 3 of the plural colors can be replaced in the MFP main body 1A, the embodiments can be applied to an image forming apparatus in which a process cartridge of one color can be replaced.

In the first embodiment and the second embodiment, the photoconductive drum 32 is not required to have a gear to drive the charging roller 34. Thus, the structure of the photoconductive drum 32 is simplified, and the length in the axial direction can be shortened without giving an influence on image formation.

The invention can be carried out in various forms without departing from the sprit or the principal feature thereof. Thus, the foregoing embodiments are merely exemplary in any points, and should not be restrictedly interpreted. The scope of the invention is described in the claims, and is not restricted by the text of the specification. Further, all modifications, various improvements, substitutions and alterations belonging to the equivalent scope of the claims are within the scope of the invention.

What is claimed is:

1. A charging device comprising:
a charge target member that rotates;
a charging member that is arranged close to the charge target member, has a same movement direction as the charge target member, and charges a charge target surface of the charge target member while rotating;
a cleaning member that makes friction contact with the charging member to, cause the charging member to be driven and rotated, and cleans a surface of the charging member; and
a cleaning member driving part to rotate and drive the cleaning member.

2. The device of claim 1, further comprising a charge target member driving part to rotate and drive the charge target member, wherein a driving source of the cleaning member driving part and a driving source of the charge target member driving part are separately provided.

3. The device of claim 1, further comprising a charge target member driving part to rotate and drive the charge target member, wherein a rotation driving force from the charge target member driving part is transmitted to the cleaning member by a rotation driving force transmission part.

4. The device of claim 1, wherein the charge target member is a photoconductive drum, the charging member is a charging roller, and the cleaning member is a cleaning roller.

5. The device of claim 1, wherein the cleaning member is a cleaning roller using a foamed body.

6. The device of claim 1, wherein the cleaning member is a cleaning roller using a brush fiber.

7. The device of claim 1, wherein the cleaning member is a cleaning roller using an elastic body.

8. A process cartridge replaceably mounted in an image forming apparatus main body, comprising:
a charge target member that rotates around a charge target member shaft to which a rotation driving force is transmitted;
a charging member that has a same movement direction as the charge target member, and charges a charge target surface of the closely arranged charge target member while rotating around a charging member shaft; and
a cleaning member that rotates around a cleaning member shaft to which a rotation driving force is transmitted, makes friction contact with the charging member to cause the charging member to be driven and rotated, and cleans a surface of the charging member.

9. The process cartridge of claim 8, wherein the charge target member shaft and the cleaning member shaft respectively include coupling parts detachably coupled to driving parts respectively provided in an image forming apparatus main body.

10. The process cartridge of claim 8, further comprising a rotation driving force transmission part to transmit rotation of the charge target member shaft to the cleaning member shaft, wherein the charge target member shaft includes a coupling part detachably coupled to a driving part provided in the image forming apparatus main body.

11. The process cartridge of claim 8,
wherein the charge target member is a photoconductive drum, the charging member is a charging roller, and the cleaning member is a cleaning roller.

12. The process cartridge of claim 8, wherein the cleaning member is a cleaning roller using a foamed body.

13. The process cartridge of claim 8, wherein the cleaning member is a cleaning roller using a brush fiber.

14. The process cartridge of claim 8, wherein the cleaning member is a cleaning roller using an elastic body.

15. An image forming apparatus in which one or a plurality of process cartridges are replaceably mounted, wherein the process cartridge comprises:
a charge target member that rotates around a charge target member shaft to which a rotation driving force is transmitted by coupling to a charge target member driving part provided in an image forming apparatus main body;
a charging member that has a same movement direction as the charge target member, and charges a charge target surface of the closely arranged charge target member while rotating around a charging member shaft; and
a cleaning member that rotates around a cleaning member shaft to which a rotation driving force is transmitted by coupling to a cleaning member driving part provided in the image forming apparatus main body, makes friction contact with the charging member to cause the charging member to be driven and rotated, and cleans a surface of the charging member.

16. An image forming apparatus in which one or a plurality of process cartridges are replaceably mounted, wherein the process cartridge comprises:
a charge target member that rotates around a charge target member shaft to which a rotation driving force is transmitted by coupling to a charge target member driving part provided in an image forming apparatus main body;
a charging member that has a same movement direction as the charge target member, and charges a charge target surface of the closely arranged charge target member while rotating around a charging member shaft;
a cleaning member that rotates around a cleaning member shaft, makes friction contact with the charging member to cause the charging member to be driven and rotated, and cleans a surface of the charging member;
a rotation driving force transmission part to transmit rotation of the charge target member shaft to the cleaning member shaft; and
a coupling part to detachably couple the charge target member shaft to the driving part provided in the image forming apparatus main body.

17. The apparatus of claim 15, wherein the charge target member is a photoconductive drum, the charging member is a charging roller, and the cleaning member is a cleaning roller.

18. The apparatus of claim 16, wherein the charge target member is a photoconductive drum, the charging member is a charging roller, and the cleaning member is a cleaning roller.

19. The apparatus of claim 15, wherein the cleaning member is a cleaning roller using a foamed body.

20. The apparatus of claim 16, wherein the cleaning member is a cleaning roller using a foamed body.
